(19) United States
(12) Patent Application Publication
(10) Pub. No.: US 2016/0258601 A1
(43) Pub. Date: Sep. 8, 2016

(54) TRANSPORTABLE LIGHTING SYSTEM

(71) Applicant: APOLLO ENERGY SERVICES CORP., Airdrie (CA)

(72) Inventor: Matthew GOWANLOCK, Airdrie (CA)

(73) Assignee: APOLLO ENERGY SERVICES CORP., Airdrie (CA)

(21) Appl. No.: 15/057,661

(22) Filed: Mar. 1, 2016

Related U.S. Application Data
(60) Provisional application No. 62/127,020, filed on Mar. 2, 2015.

(51) Int. Cl. F21V 15/04; F21V 21/30; F21V 21/14; F21V 21/22; F21L 2/00; F21L 13/00

(52) U.S. Cl. CPC F21V 15/04; F21L 2/00; F21L 13/00; F21V 21/145; F21V 21/22; F21V 21/30; F21W 2131/1005

(57) ABSTRACT

A portable lighting system for a drilling rig. The lighting system is designed to withstand the difficult and extreme weather conditions typically experienced in drilling rig environments. The pulley and slider arraignments are designed for minimal friction. The overall pulley design for the lifting of the unit (for, example, the way the cables are orientated) is extremely robust. The outrigger design include fold out and lock in place. The power source can run a duel transfer switch setup powered by an external supply (like the rig power) or from its own 100% backed up generator. Lighting is the lightest and brightest available. Tower is skid mounted and mobile with the use of a truck. Top light banks swivel and tilt.

### CROSS-REFERENCE TO RELATED APPLICATION

The instant application is a U.S. Nonprovisional Application claiming the benefit under 35 U.S.C. §119(e) of U.S. Provisional Application No. 62/127,020 filed Mar. 2, 2015, the disclosure of which is expressly incorporated by reference herein in its entirety.

### FIELD OF ART

The present invention relates generally to the field of lighting systems, and in particular to lighting systems for use with oil drilling, mining, construction and any operations utilizing mobile lighting equipment

### BACKGROUND

Drilling rigs are used to form wellbores for the purpose of extracting oil, natural gas or other fluids from subsurface deposits. Drilling rigs can also be used for sampling subsurface mineral deposits, testing rock or ground fluid properties and for installing subsurface utilities, instrumentations, tunnels or wells. In implementation, drilling rigs may be mobile equipment transportable by truck, rail, trailers, or similar, rigs may also be semi-permanent and permanent fixtures as in the case for oil drilling of large wells. Marine-based structures are also widely known. Generally, the term drilling rig refers to an arrangement of equipment that is used to penetrate the subsurface of the earth's crust.

Drilling operations typically occur during daylight hours and visibility in and around the drilling rig has historically only been required when manual work is being done, inspection and calibration, for example. There is a desire to increase productivity by providing visibility during hours of low daylight, and this has thus far been accomplished by providing mobile lighting arrangements on vehicles proximate the drilling rig, or otherwise manually adding impromptu lighting arrangements.

However, because of the extreme weather conditions drilling operations typically occur in, for example high and low temperature conditions, and variable including high wind conditions, many lighting systems for this use and environment have been found to be inadequate for this purpose.

### BRIEF SUMMARY

A transportable lighting system is described including a transportable, skid base, a stabilizing outrigger system attached to the base, at least one power generator attached to the skid base, a transfer switch connected to the power generator, an external power supply adapter connected to the transfer switch, an extendable tower system have a base end and a top end attached to the skid base, and at least one set of lights attached to the top end.

Additional embodiments include: the lighting system described above where the lighting system has a top load capacity of up to 500 pounds and is stable in sustained winds of 70 mph and wind gusts up to 140 miles per hour; the lighting system described above where the stabilizing outrigger system comprises four, fold-out, lock-in-place, extendable legs; the lighting system described above including at least one power generator attached to the skid base; the lighting system described above where at least one power generator is connected to the external power supply by a transfer switch; the lighting system described above have two power generators; the lighting system described above including a transfer switch connecting the two power generators; the lighting system described above where the set of lights can swivel and/or tilt; the lighting system described above where the tower system comprises at least two tower sections containing a cable extension system within the tower sections; the lighting system described above where tower system includes at least three tower sections, containing a cable extension system within the tower sections; the lighting system described above where the tower system contains five tower sections containing a cable extension system within the tower sections; the lighting system described above where the tower system is fully extended.

These, and additional embodiments, will be apparent from the following descriptions.

### BRIEF DESCRIPTION OF THE DRAWINGS

FIGS. 1a and 1b are side views of a lighting system described herein in the transport position.

FIG. 2 is a perspective view of a lighting system described herein in the field or expanded position.

FIG. 3 is an exploded view of a structural support pin described herein.

FIGS. 4 is a cross sectional view of a support structure from FIG. 1b described herein.

FIG. 5 is an exploded view of a structural connection point from FIG. 1b described herein.

FIG. 6 is a perspective view of a lighting system described herein with the tower hidden.

FIG. 7 is a schematic view of the top of a lighting system skid as described herein.

FIG. 8 shows a perspective view of a light bank system described herein.

FIGS. 9a and 9b show a cut away and non-cut away view of a cable and pulley system as described herein.

### DETAILED DESCRIPTION

The particulars shown herein are by way of example and for purposes of illustrative discussion of the various embodiments of the present invention only and are presented in the cause of providing what is believed to be the most useful and readily understood description of the principles and conceptual aspects of the invention. In this regard, no attempt is made to show details of the invention in more detail than is necessary for a fundamental understanding of the invention, the description making apparent to those skilled in the art how the several forms of the invention may be embodied in practice.

The present invention will now be described by reference to more detailed embodiments. This invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise. All publications, patent applications, patents, and other references mentioned herein are expressly incorporated by reference in their entirety.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should be construed in light of the number of significant digits and ordinary rounding approaches.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Every numerical range given throughout this specification will include every narrower numerical range that falls within such broader numerical range, as if such narrower numerical ranges were all expressly written herein.

Additional advantages of the invention will be set forth in part in the description which follows, and in part will be obvious from the description, or may be learned by practice of the invention. It is to be understood that both the foregoing general description and the following detailed description are exemplary and explanatory only and are not restrictive of the invention, as claimed.

As described above, the lighting systems described herein are specifically designed to withstand the difficult and extreme weather conditions typically experienced in drilling rig environments. For example, the lighting systems described herein can withstand sustained wind speeds of up to about 70 miles per hour (MPH) and brief wind gusts (e.g., up to 3 seconds) of up to about 140 MPH. The systems are also designed and built to Canadian −45 (degree Celsius) structural cold weather steel ductility requirements, which represent extremely stringent standards.

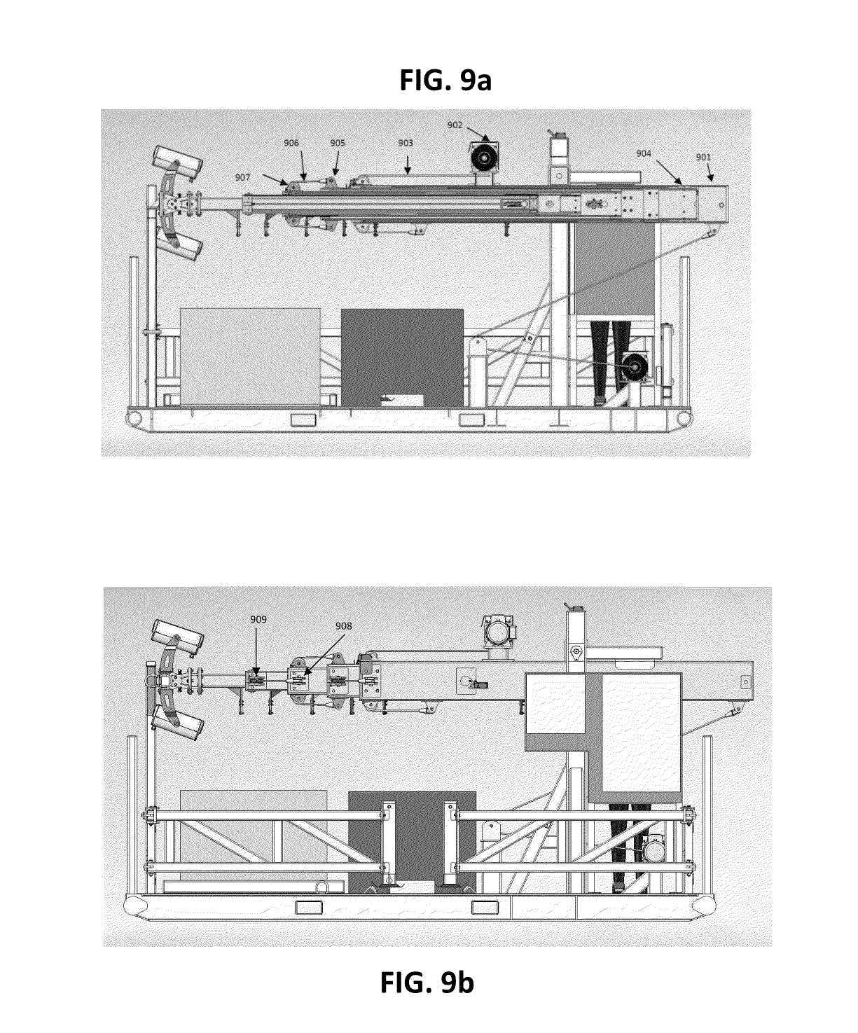

The slider, pulley and wheel arraignments described herein are designed for minimal friction, including one piece sliding bushings (see, for example 904 in FIG. 9a).

The power source for powering the lights and extending and contracting the telescopic lighting system towers typically contain dual power transfer switches. Power source can be external, such as that used to provide power to the drilling rig, for example, or the internal generator and/or optional backup generator contained in the lighting system itself. One switch provides the ability to switch between generators and an additional switch provides the ability to switch from the internal generators to an external power source. The switches can be manually or automatically operated, although automatic operation (e.g., triggered by failure of one of the power sources), would add additional cost to accommodate.

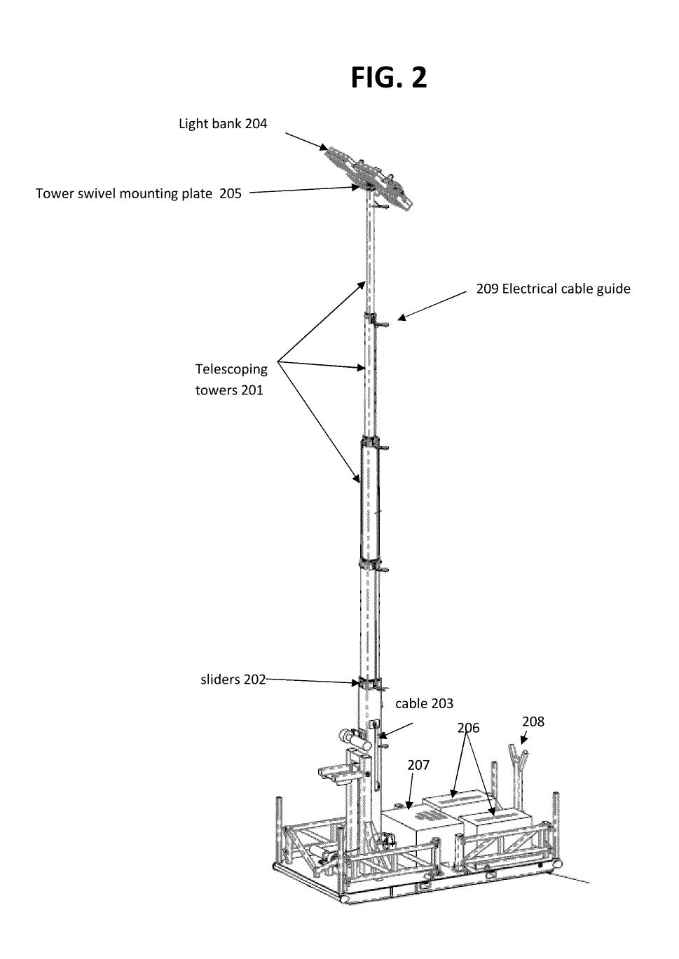

The overall pulley design and slider system for the lifting of the unit (for, example, the way the cables are orientated) is extremely robust. As demonstrated in FIG. 2, for example, the towers 21 are sized so as to fit one within another to allow for telescopic expansion when desired. The tower guide sliders 202 help to minimize friction within the system and provide added structural stability.

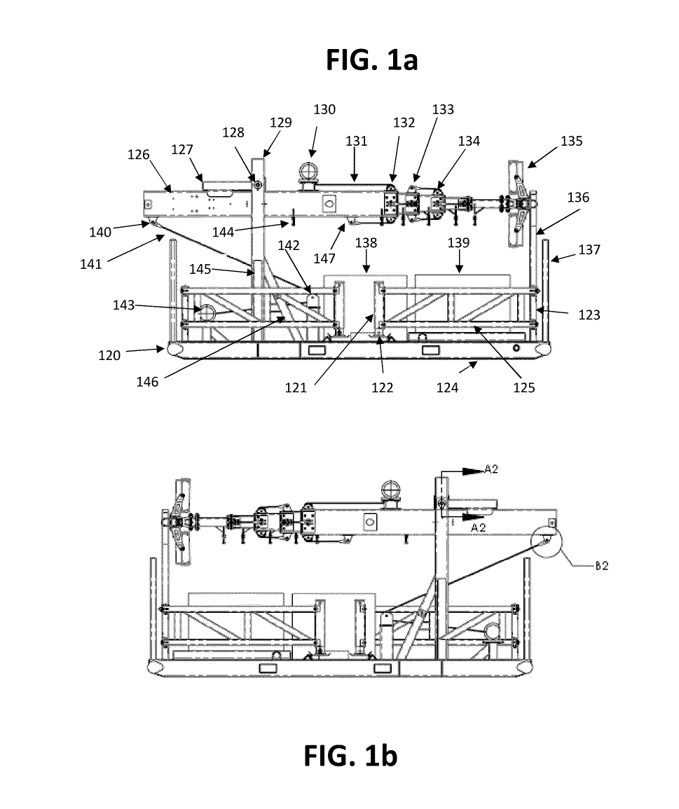

The outrigger design (fold out and lock in place), while relative simple, is easy to use and works extremely well—quick, safe and efficient in set up. As demonstrated, for example, in FIGS. 1 and 6, it can basically be made up of a jack 121 containing an adjustable base 122 which sits on the ground when extended, connected to a post 123 securely attached to skid base 124 through a structure 125 of parallel vertical, horizontal and angles bars. The bars lock in place when extended (601 in FIG. 6) to provide extreme stability (as described herein), to the extended tower structure.

The overall layout of the system described herein, as demonstrated by FIG. 6 for example, including the wide footprint, is extremely stable, and can accomplish the described wind resistance without the need for added guide wires, anchors, or other external stability aids.

The system described herein includes duel transfer switch setup to allow the lighting system to be powered by an external power supply (for example, like power supply powering the rig power) or from its own generator and optionally a 100% power back-up generator. So the first transfer switch will allow switching from a first internal generator to a second internal generator and the second transfer switch will allow switching from the first or second internal generator to an external power source.

The individual lights used in the system should be bright, but also light. The light to weight ratio of the light fixture should be as high as possible. For example, about 1000 lumens per pound could typically be used.

As mentioned, the lighting system is skid mounted and completely mobile, while providing extreme temperature and weather tolerance and wind stability. It is relatively easy to move with the use of conventional trucks and extremely easy to set up for use and operate.

For example, the entire light bank can swivel and tilt. This allows them to be preset before extension or moved after extension to accommodate the particular lighting requirements desired. FIG. 2 shows a bank 204 of four lights useful herein, including a light tower swivel mounting plate 205 which provides for light movement for light bank in a horizontal or vertical direction.

As can be appreciated, while the towers described herein are particularly useful extended to heights of about 45 feet, they can be used at heights below 45 feet, e.g., 20 feet, 30 feet, etc., and designed for use at extended heights greater than 45 feet as well. In a representative system as shown in FIG. 1, a portable lighting system as described herein is mounted on a skid 124. The skid is provided with “ears” or attaching points on all four corners to facilitate skid cable or other connections for loading and unloading, for example, with a winch tractor. The skid and its attached parts are typically all made of steel. The structural supports 137, one on each corner, provide protection while being loaded and unloaded from the transportation trucks. The tower sections 126 are secured to the structural transport center post 129. 127 is a stopper plate for when the tower is horizontal for transportation. The connection point to center post 129 is through the hinge pin 128. On the tower there is a hinge section attached to the mast (not shown, but on the back side of post 129). It is typically a rectangle section attached to the mast and that's what the pin 128 slides through. The stopper plate 127 is fixed in its position, does not move and together with its attached hinge pin 128 provides the pivot point in the structure to allow the telescoping tower sections to go from the horizontal transport position to the vertical position desired in use. Cable 141 provides the leverage to raise the tower through connection point 140 and drive motor 143, traveling around guide pulley 142. Cable guides 144 (e.g., round holes) allow the electrical cable to slide through.

Once in the vertical position, the tower sections all rise together, until extended to their full (e.g., 45 foot) height. The cables 131 are drawn around pulley 132, for example, by pulley/cable hoist 130, causing the tower sections to extend and rise. In the extended position, when desired, gravity returns the tower to a lower position, safely controlled by maintaining the desired tension on the cables through the hoist and pulley system as the towers re-collapse into each other.

The cables are secured to the tower sections by anchor point 133. The cable sheaves 134 are also shown. The light bank 135 rests on and is secured to the light bank support 136 during transport and when not in use. The fuel (typically diesel) tank 138 and one of the internal generators 139 are also shown.

The exemplary standalone 45 foot tower 126 depicted in FIG. 1 has five sections which telescope out, and up, as the tower is extended. The main members of the tower sections are typically made of steel HSS (Hollow Structural Solutions) tubing and plate steel. Extending the tower cables cause the required action to extend each section simultaneously and when extended, the additional tower sections are held in place by the cables that are attached. For example, cable 134 runs between the third and fourth mast sections and wraps around pulleys (pulleys not shown) at the bottom of the fourth section and comes back up the other side of the mast and is anchored at the same location it started at but on the other side of the mast (shown on bottom side of mast mirror image of 133). 127 is a resting structure for the masts during transport. A representative steel skid is shown as 124.

The lights as described herein are similar to the lights shown in commonly assigned, copending U.S. patent applications Ser. No. 14/093,097, filed Nov. 29, 2013, and Ser. No. 62/109,966, filed Jan. 30, 2015, the disclosures of which are herein incorporated by reference. The entire light bank can both tilt and swivel to better focus the lights on the intended illumination target. The light frame is typically aluminum for weight reasons, although other materials can be used. The light frame tilt and swivel mechanism, is between the frame and the tower.

138 is a double walled fuel tank containing the fuel to power the (optionally two) attached power generators (139 in FIG. 1a and 206 in FIG. 2). Diesel fuel is the fuel preferred. The tank is typically designed to meet all fuel tank transportation approvals. One such tank is offered by Petro Industries. Seven to thirteen kilowatt commercially available generators are particularly useful. 121 indicates one of the four conventional, commercially available jacks provided in the outrigger system, which swings out (601 in FIG. 6), and is crank adjusted to accommodate the ground level adjustments needed for skid and tower stability, using conventional levels for appropriate ground level adjustment.

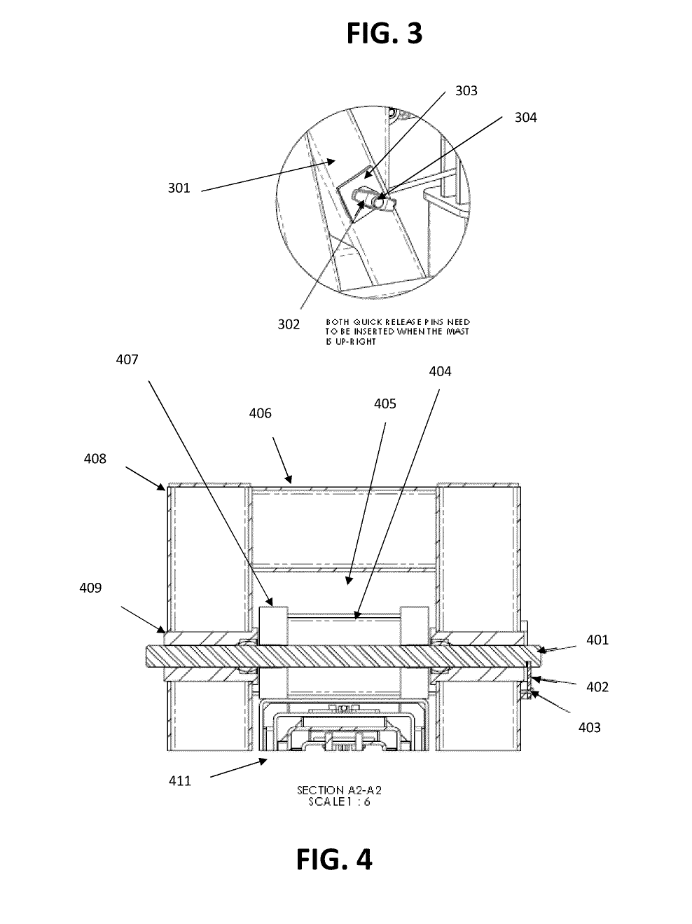

FIG. 3 shows the locking pins that are used to secure the tower in the vertical position for operation. There are 2 pins one located on each side of the mast. 301 is the cross member 146 that is supporting 129 in FIG. 1a. 302 is the locking pin. 303 is a reinforcement plate welded on for the pin connection to accommodate the significant stress that can be applied there. 304 is the release button on the locking pin

FIG. 4 shows the tower tilt pin and cross section of masts (top view). 401 is the tilt pin (128 in FIG. 1a). Piece 402 is used to secure the pin in place (to help prevent it from sliding out). 403 is a bolt that helps secure 402 in place. 404 and 407 are part of the structure allowing for the tilt pin to attach to the mast (404 and 407 are attached to the mast and have a hole through which the pin slides through and acts as the axis point). 405 is just open space. If the tower was in a horizontal position, the collapsed mast sections would be resting on 408, and 406. 406 is the plate the tower rests on when horizontal (127 in FIG. 1a). 407 is a structural section mounted to tower sections to allow for tilting. 408 is part of the structure that holds 406 attached to 129 in FIG. 1a. 409 are the machined sleeves for the pin to slide through (bushing are mounted inside to reduce friction). 411 is a top view cross section of the masts.

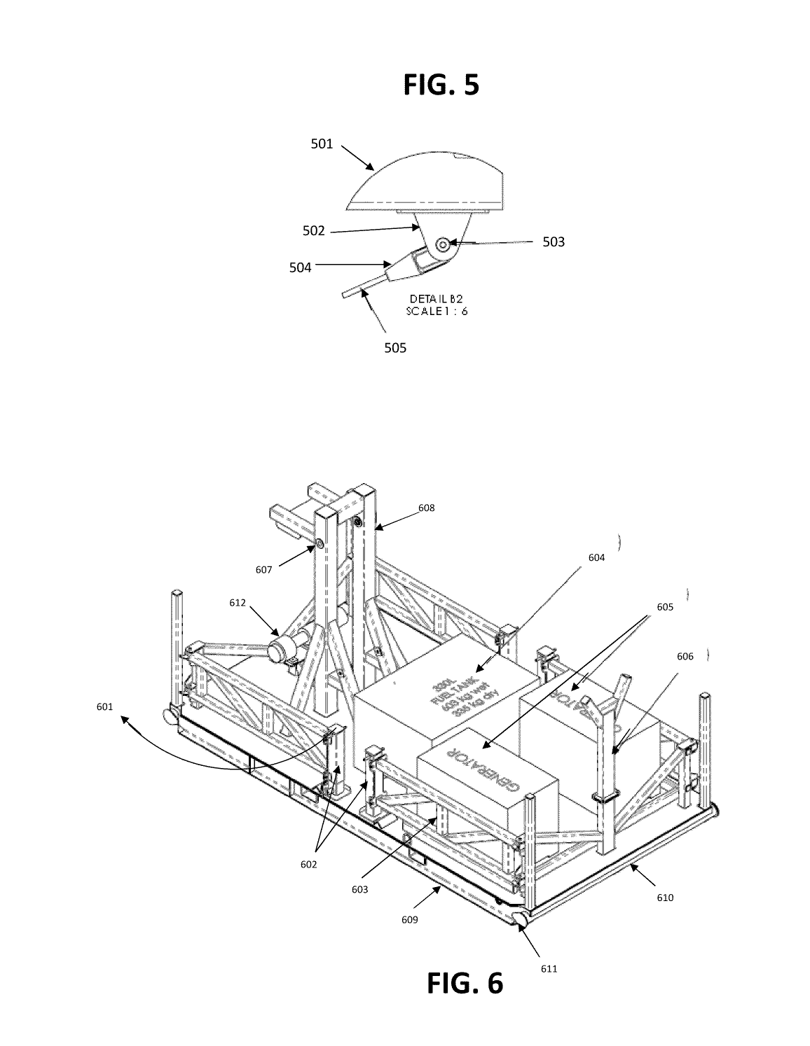

FIG. 5 shows a typical anchor point for the mast cable system. 501 is the mast section. 502 is the anchor point that hold the bolt that is feed through the cable eye (end of cable) there are two of these about 2″ apart and a bolt goes through holding the cable end. 503 is the bolt as mentioned in above. 504 is the cable eye and there are many types that can be used we are using what they call a thimble end for cost reasons. 505 is the cable.

In FIG. 6, a perspective view of a segment of the system at ground level (tower sections not shown) the adjustable jacks 602 jacks are shown (direction of swing in open position indicated by 601), providing stability on even and uneven surfaces, attached to the stabilizing bars 603 of the outrigger system. The (diesel) fuel tank 604 can supply power to generators 605. 607 is the hinge point connecting the lower tower section to the skid. 608 are stabilizing bars for stabilizing the lower tower section to the skid. 609 are the skids. 610 is the front a roll bar, part of the skid, to assist in loading and unloading the skid during transport, with “ear” 611 for attaching cable when used to assist in loading and unloading. 606 is a stationary support bar for anchoring the tower sections during transport, for example. 612 is the motor system for attachment to the cable which lifts and lowers the lighting system from vertical to horizontal and vice-versa.

The lighting system is shown fully extended in FIG. 2. The light bank 204 is connected to the tower section 201 through a tower swivel mounting plate 205. The cable system sliders are made up of robust, typically non-metallic material with low friction properties, e.g., conventional plastic materials such as polypropylene, polyethylene, polytetrafluoroethylene, DELRIN® resin, UHMW (ultra high molecular weight polyethene) plastic, etc. The cable system is present inside all of the masts or tower sections. The power generators 206, fuel tank 207 and structural support for the bank of lights during transport 208 are also shown. Electrical cable guide 209 is also shown. As the slider and pulley system pushes the second tower section out of the first tower section, the pulley system is in place to cause all of the towers to begin to extend simultaneously. The second tower section is pulled up out of the first tower section by hoist 130 and cable 131 (FIG. 1a). Cable 131 travels under the second mast section through pulleys that are located at the bottom of the second section and the cable is anchored at the anchor point 147. So as hoist 130 pulls the cable in, it raises all sections at once.

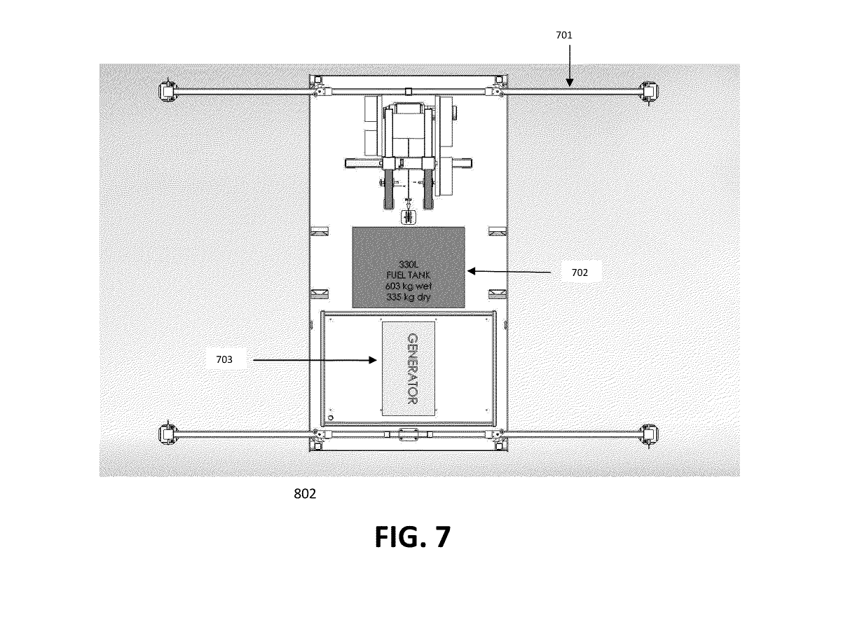

FIG. 7 is a schematic view of the top of a lighting system skid as described herein, including the outrigger system 701 fully extended, and the fuel tank 702 for supplying the generator 703.

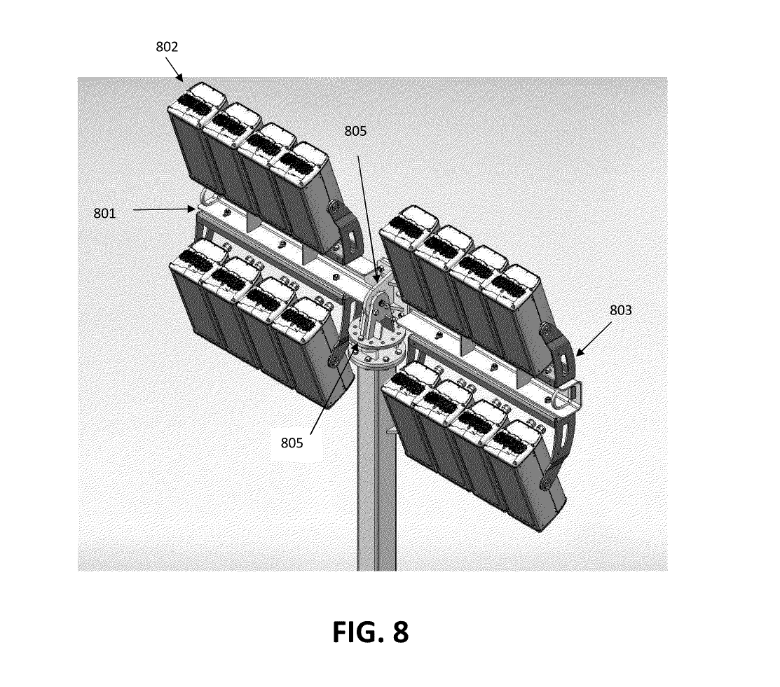

FIG. 8 shows a perspective view of a light bank as described herein, including a light frame 801for supporting the bank of lights 802, a light bracket 803 which provides for the tilting of the light bank, light swivel mounts which allows for rotation 804 of the light frame and tilting 805 of the entire bank of lights.

As shown in FIG. 9a, 901 is lifted into a vertical position and once it is locked vertically, hoist 902 contracts cable 903 connected to the bottom of the second section at the point where the slider bushings 904 are also attached to the tower section. This causes the second section to extend as all sections of the tower are lifted into an extended vertical position. With the extension of the second section, the third section with cable attach point 905 also extends as the tension on the cable 906 increases, causing the third section to slide up as the cable rolls on pulley 907 attached to the fourth section. The cable attach point 908 for the fourth section and its pulley 909 attached to the fifty section can be seen in FIG. 9b.

The scope of the claims should not be limited by the preferred embodiments set forth in description of the preferred embodiments or in the examples, but should be given the broadest interpretation consistent with the description as a whole.

1. A transportable lighting system comprising:
a. a transportable, skid base,
b. a stabilizing outrigger system attached to the base,
c. at least one power generator attached to the skid base,
d. a transfer switch connected to at least one power generator,
e. an external power supply adapter connected to the transfer switch,
f. an extendable tower system have a base end and a top end attached to the skid base, and
g. at least one set of lights attached to the top end.

2. The lighting system of claim 1 wherein the lighting system has a top load capacity of up to 500 pounds and is stable in sustained winds of 70 mph and wind gusts up to 140 miles per hour.

3. The lighting system according to claim 1, wherein the stabilizing outrigger system comprises four, fold-out, lock-in-place, extendable legs.

4. The lighting system according to claim 1, including at least one power generator attached to the skid base.

5. The lighting system according to claim 4, wherein at least one power generator is connected to the external power supply by a transfer switch.

6. The lighting system of claim 1 having two power generators.

7. The lighting system of claim 6 including a transfer switch connecting the two power generators.

8. The lighting system according to claim 1, wherein the set of lights can swivel and/or tilt.

9. The lighting system according to claim 1, wherein the tower system comprises at least two tower sections containing a cable extension system within the tower sections.

10. The lighting system according to claim 1, wherein the tower system comprises at least three tower sections containing a cable extension system within the tower sections.

11. The lighting system according to claim 7, wherein the tower system comprises five tower sections containing a cable extension system within the tower sections.

12. The lighting system according to claim 1, wherein the tower system is fully extended.
